(19) United States
(12) Patent Application Publication
(10) Pub. No.: US 2008/0232263 A1
(43) Pub. Date: Sep. 25, 2008

(54) System and method for correlating a network packet exchange with a period of a transaction

(76) Inventor: Amichai Lesser, Hoboken, NJ (US)

Correspondence Address: Pearl Cohen Zedek Latzer, LLP, 1500 Broadway, 12th Floor, New York, NY, 10036, US

(21) Appl. No.: 11/723,575

(22) Filed: Mar. 21, 2007

(51) Int. Cl. H04J 1/16

(52) U.S. Cl. 370/252; 370/401

(57) ABSTRACT

A system and method of associating a period of a transaction over an IP network with the packet exchanges of data or functions on the IP network during such period.

### FIELD OF THE INVENTION

The present invention generally relates to network applications. More particularly, the present invention relates to a system and method for correlating exchanges of packets between nodes of a network with a period during which a transaction is executed.

### BACKGROUND OF THE INVENTION

Existing tools provide lists or records of exchanges of information such as data between two or more nodes or points of an IP network during the course of an execution of a transaction of an application. A sample of such a list is presented in FIG. 1. One or more commands or requests that may be sent for example by a client to one or more servers may precipitate a series of exchanges of data or signals such as packets between for example the client and the server or among other servers or components connected to the IP network. For example, a first exchange may transmit input data that may be included in several packets that are delivered from a client to the server. A second exchange may send related data from the client to the server or from a data base to the server or from the server to the client, and a third exchange may send the data as processed by a processor associated with the server from the server back to the client. A single transaction may entail numerous such exchanges. One or more of such exchanges may be included in a packet or in a series of transmitted packets. A user who may analyze the exchanges of data may desire to know which packets are parts of the execution of which transaction.

### SUMMARY OF THE INVENTION

Embodiments of the invention may include a method for executing a transaction over an IP network, recording a time of a start of the transaction and a time of an end of the transaction, recording exchanges of data included in the transaction among nodes on the IP network occurring between the time of start and the time of end, and displaying the exchanges with an indication of which exchanges occurred during the execution of which transaction of the application.

In some embodiments, a method may include recording a time of a start of a transaction over the virtual IP network under a first network condition and a second network condition of the virtual IP network, and a time of an end of the transaction when executed on the virtual IP network under the first and second network conditions, recording exchanges of data between the two nodes on the virtual IP network between the time of a start of the transaction and the time of end of the transaction over the virtual IP network under the first network conditions, and recording exchanges of data between the two nodes on the virtual IP network between the time of a start of the transaction and the time of end of the transaction over the virtual IP network under the-second conditions

In some embodiments, a method may include associating the exchanges and the transaction with a period between the start and end times.

In some embodiments, a method may include executing a transaction of an application over a virtual IP network, executing the same or similar transaction on a modified version of the application, recording the start and end time of the transaction on the modified version, recording the exchanges of data during the period associated with the transaction, and displaying a comparison of the exchanges that are associated with the transaction in each, of the two versions of the application.

In some embodiments, a method of displaying a transaction of an application over a network may include displaying an indication of a transaction executed on an IP network, displaying an indication of one or more exchanges between nodes on the IP network during the execution of the transaction, and displaying an indication of an association of the exchanges with the transaction. In some embodiments displaying the indication of the association may include displaying an indication that the exchanges were executed in the course of the transaction. In some embodiments the display may include an indication of a time period during which the transaction was executed. In some embodiments, the display may include an indication of a time period during which the exchanges occurred.

In some embodiments, the display may include an indication of more than one transaction, and the exchanges associated with each of the more than one transactions.

In some embodiments, a transaction may be run over a network such as a virtual IP network, where the network is subject to a first condition or constraint, and then the same or similar transaction may be run over the network when the network is subject to a second condition or constraint. The exchanges may be associated with the two runs of the transaction, and the exchanges may be compared and the comparisons displayed. In some embodiments, the network may be kept constant, and the application may be altered such that a transaction may be run on a first version of the application and a second version of the application. A comparison can be made and shown between the exchanges resulting from the two versions.

### BRIEF DESCRIPTION OF THE DRAWINGS

The subject-matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a list in accordance with the prior art of a series of exchanges of packets between two or more points or nodes connected to an IP network in the course of execution of transactions;

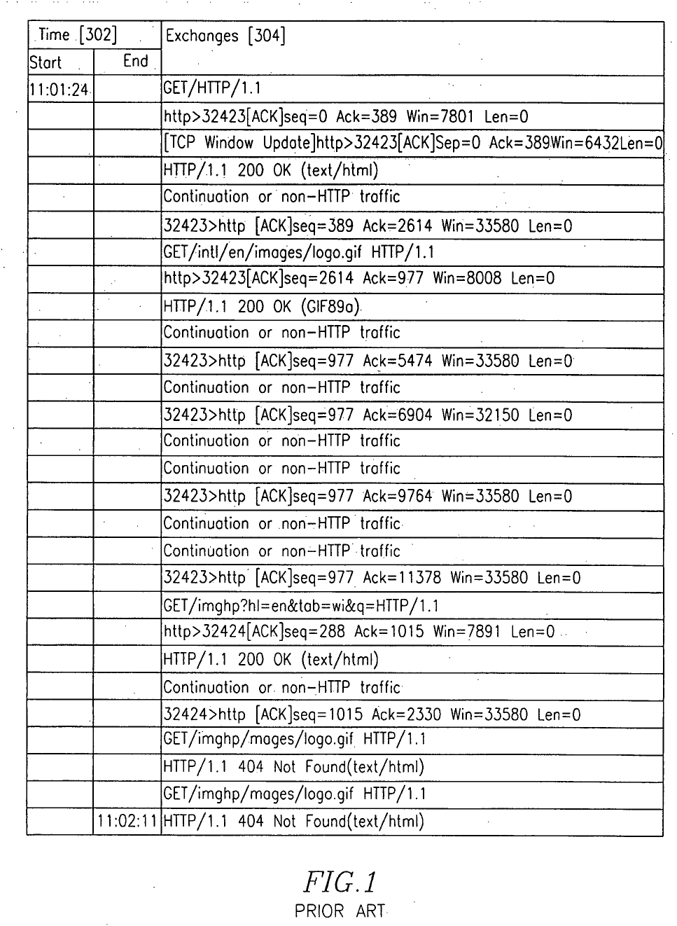

FIG. 2 a conceptual illustration of an IP network, in accordance with a preferred embodiment of the present invention;

FIG. 3 is a conceptual illustration of an association of execution of transactions over an IP network and times of such executions with exchanges of packets during such times of execution in accordance with a preferred embodiment of the present invention; and

FIG. 4 is a flow diagram of a method in accordance with an embodiment of the invention.

### DETAILED DESCRIPTION OF THE PREFERRED EMBODIMENTS

In the following description, various embodiments of the invention will be described. For purposes of explanation, specific examples are set forth in order to provide a thorough understanding of at least one embodiment of the invention. However, it will also be apparent to one skilled in the art that other embodiments of the invention are not limited to the examples described herein. Furthermore, well-known features may be omitted or simplified in order not to obscure embodiments of the invention described herein.

Unless specifically stated otherwise, as apparent from the following discussions, it is appreciated that throughout the specification, discussions utilizing terms such as “selecting,” “evaluating,” “processing,” “computing,” “calculating,” “associating,” “determining,” “designating,” “allocating” or the like, refer to the actions and/or processes of a computer, computer processor or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and functions presented herein are not inherently related to any particular computer, network or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein. In some embodiments, one or more methods of embodiments of the invention may be stored on an article such as a memory device, where such instructions upon execution result in a method of an embodiment of the invention.

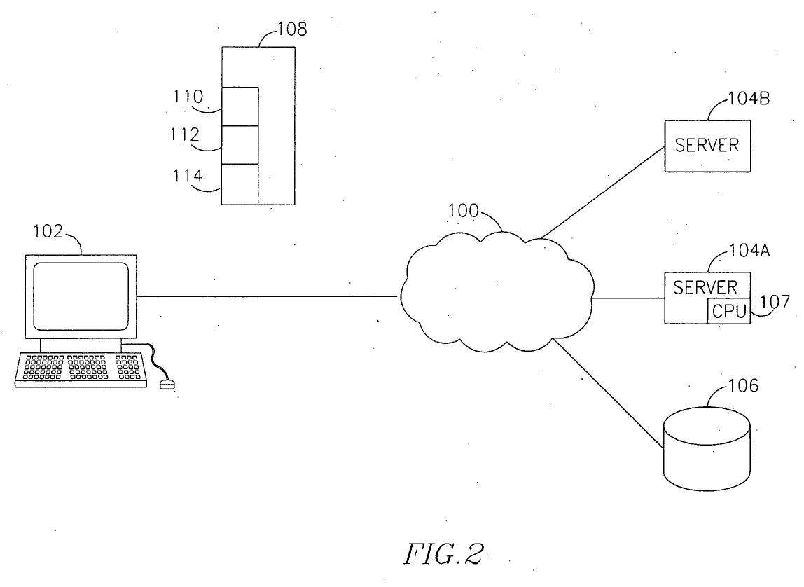

Reference is made to FIG. 2, a conceptual illustration of end points of an IP network, in accordance with a preferred embodiment of the present invention. In some embodiments, an end-point or node of an IP network 100, may include one or more clients 102 that may be connected to IP network 100, and one or more servers 104A and 104B that may include one or more processors 107, one or more data bases 106, and/or other components or sources of computational power or data that may be connected to IP network 100. In some embodiments, IP network 100 may be or include a wide area network such as the Internet, a local area network (LAN), a combination of a LAN that is connected to a WAN, a simulated or virtual IP network or another IP network. Client 102 may be a device suitable to connect to IP network 100 and in some embodiments, client 102 may be a computer, work station, IP phone or other electronic device suitable to receive or respond to commands from other points on IP network 100.

In some embodiments, a tool or device 108 may be connected to for example IP network 100 and/or may be connected to or included in client 102 or in for example server 104 or in another device. Device 108 may include a processor 110, such as for example a central processing unit, and a memory 112, such as for example, a hard drive, flash memory or other mass data storage unit. In some embodiments, device 108 may include software or other instructions that may collect or record a series of exchanges, commands or functions that may be performed by client 102 and/or for example one or more servers 104A and 104B or other components attached to the network 100. For example, in the course of executing a transaction of an application, such as for example a request of client 102 to download a web page, client 102 may issue a browsing command or other request to receive a web page or other resource. The command such as a ‘get’ command may be deemed a beginning or start of a transaction of a web application. Other transactions of other applications may be used.

The transaction may be initiated by for example a delivery of one or more packets from the client 102 to server 104A. Server 104A may send a confirmation packet to client 102 that it received the request. Server 104A may send one or more additional packets that may include data about one or more components of for example the requested web page or data from a data base. In addition, client 102 may be prompted to send one or more packets to server 104B to request additional components of the web page. Server 104B may send one or more confirmation packets to client 102, and may also send one or more data packets to client 102. Client 102 may send one or more confirmation packets to server 104A and server 104B to indicate its receipt or failure to receive such packets.

In all, a transaction may include several packets or exchanges that may be delivered to or from one or more servers 104, data bases or other nodes of an IP network to a client 102. In some embodiments, a transaction may include a single command or function from a client or other component on an IP network. In some embodiments, a transaction may include numerous functions or commands that may or may not be related or linked to provide one or more functional processes over a network 100.

In some embodiments, device 108 or some other component connected to or in contact with network 100 may include one or more timers 114 that may record or assign a time for a beginning of a transaction of an application and an end of a transaction of the application. In some embodiments, timer 114 may also record a time of one or more functions or exchanges of data, signals or packets that are transmitted in the course of executing or completing a particular transaction. In some embodiments, timer 114 may record or assign a time of day to a beginning and/or to an end of a transaction or to an exchange of data, signals or packets that may be included in the transaction. In some embodiments, timer 114 may assign a time period relating other than to a time of day.

In operation and in some embodiments, one or more transactions of one or more applications may be executed over IP network 100 between two or more components on the network 100. For example a client 102 may request data about an airline flight, and may submit payment information for a ticket on such flight. Timer 114 may record a time or beginning of an interval that may start when for example the request for such confirmation or request for flight data is submitted by client 102. In some embodiments, the request for information may be considered as a single transaction. Timer 114 may also record a time or end of a period during which a transaction has been executed. For example, in some embodiments, the submission by client 102 of a request for flight data may be considered a start of a transaction, and the receipt by the client of an indication that its request has been received by server 104 may be considered the end of the transaction. In some embodiments a request for flight data may be considered a start of a transaction, and a receipt of confirmation of a reservation for a flight may be considered as an end of a transaction. Timer 114 may record a time of a start or beginning of such transaction and a time of and end of such transaction. Other commands or functions having other purposes or procedures may be considered a transaction.

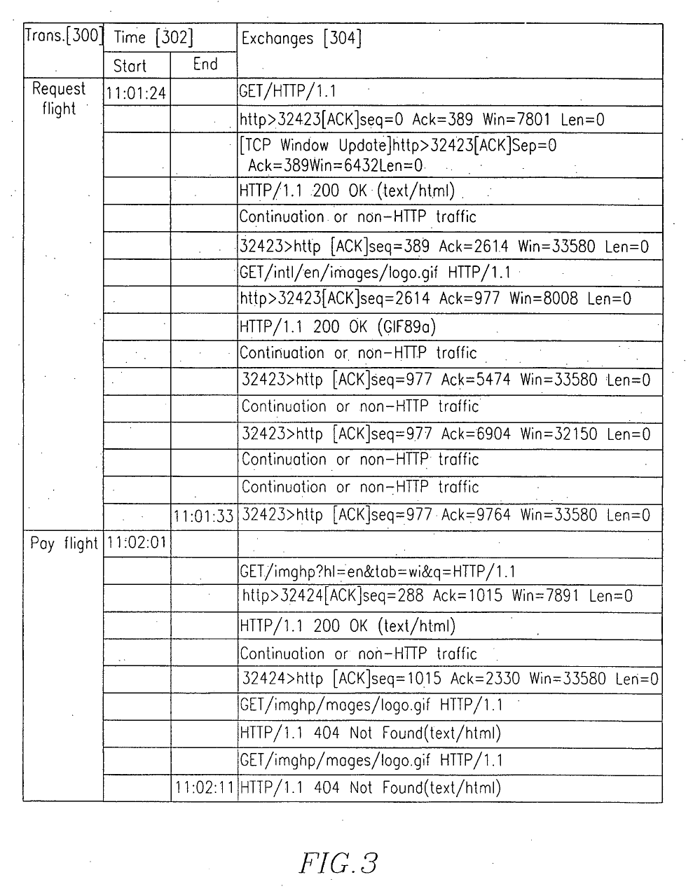

Reference is made to FIG. 3, a conceptual illustration of a display of execution of transactions over an IP network and times of such executions, along with an indication of exchanges of packets that occurred during such times of execution, as such exchanges of packets are coordinated or associated with the transactions, in accordance with a preferred embodiment of the present invention. Column 300 may indicate, collect or list transactions that may have been executed by for example client 102 over an IP network 100. Column 302 may record a time of start and a time of end of one or more transactions. Column 304 may record exchanges or retrievals of packets that may have been executed during the time period between the start of the transaction and the end of the transaction. In some embodiments, the transaction and its associated exchanges, functions or retrievals may be displayed other than in columns. For example, a list may be generated that shows the transaction and the exchanges of packets, and data about such exchanges. The time or the time period may or may not be shown.

In some embodiments, a display may show an indication of a transaction executed on an IP network 100, along with an indication of exchanges of packets between one or more nodes on the IP network 100 during the execution of the transaction, and an indication of an association of the exchanges of packets with the transaction. In some embodiments the display may include an indication that the exchanges were executed in the course of the transaction. In some embodiments the display may include an indication of a time period in which the transaction was executed and the time period during which one or more of the exchanges occurred.

In some embodiments, device 108, such as for example a sniffer or other recording device, may, during the one or more transactions between client 102 and server 104A or server 104B, record the exchanges of data and signals that are sent to, from or between any of client 102 and server 104A. Timer 114 or another timer or marker may mark or associate such one or more recorded exchanges or functions with a time or period when the exchange or function occurred or was processed.

In some embodiments, a processor that may be in or associated with device 108, may associate or correlate a time period of a start of a transaction and an end of the transaction, with the exchanges of packets that occurred during that period and that related to the transaction. In some embodiments, the exchanges of packets that occurred during the designated time or period of the transaction may be collected or for example displayed under a heading of the particular transaction. A user may be able to view the exchanges of packets associated with the transaction and may be able to collect and view metrics about exchanges of packets associated with the transaction.

In some embodiments, a marking or association of exchanges of packets with a transaction may be displayed by for example, indicating the transaction, and for example indenting the exchanges of packets inward from the transaction, so that the exchanges of packets are listed under the transaction. In some embodiments, a transaction and its associated exchanges of packets may be shaded or otherwise colored to indicate that the exchanges of packets belong to a particular transaction. Other indications may be used.

In some embodiments, a display may indicate a comparison of two similar transactions and the packets exchanges that were executed in respect of each of such similar transactions. For example, a user may execute a first transaction such as for example a log-on transaction of an application under a first constraint, network setting or programming procedure. A user may then execute a same or similar log-on transaction under a second constraint, setting or application version. In some embodiments, the two transactions may be run using for example different or modified versions of the program or application procedure. Device 108 may record the time of the start and the end of the two transactions, respectively, and collect, record or classify the packet or data exchanges in each of the two periods. A processor may collect, list or display the packet exchanges that were entailed or triggered by each of the transactions under each of the two constraints. A comparison may be made of the number, complexity, speed, chattiness, efficiency or other characteristics or metrics of some or all of the packet exchanges as part of an analysis of the effects. Similarly, a user may execute the same or similar transactions under two or more network conditions, such as for example under different network bandwidth constraints, and may compare an effect that the network conditions may have on the number of packet exchanges or the speed or efficiency of such packet exchanges.

In some embodiments, changes in constraints or conditions may be made or simulated on for example an emulating device that may emulate network conditions, and on which an application or transaction between for example a virtual client 102 and one or more virtual servers 104 or data bases 106 may be executed. In some embodiments, one or more of client 102, servers 104 and data bases 106 may be either real or virtual. In some embodiments network 100 may be virtual while all other components are real.

In some embodiments, the invention may include an indication of a transaction executed on an IP network 100, an indication of packet exchanges between one or more nodes on the IP network 100 during the execution of the transaction, and an indication of an association of the packet exchanges with the transaction. In some embodiments the display may include an indication that the packet exchanges were executed in the course of the transaction. In some embodiments the display may include an indication of a time period in which the transaction was executed and the time period during which one or more of the packet exchanges occurred. In some embodiments the display may include metrics of a transaction based on the packets included in it. In some embodiments these metrics may be saved, aggregated or otherwise collected without being displayed.

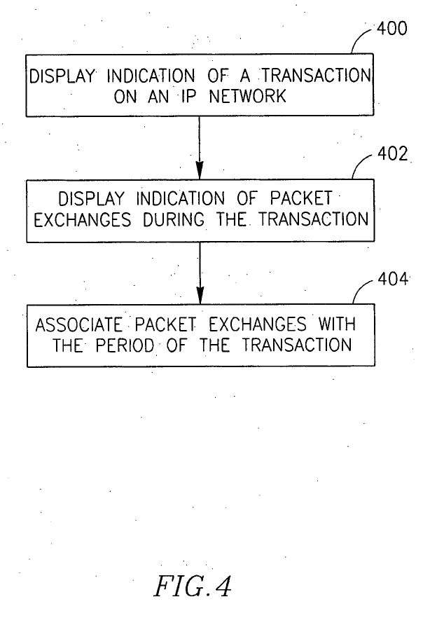

Reference is made to FIG. 4, a flow diagram of a method in accordance with an embodiment of the invention. Is some embodiments and in block 400, a method may include displaying an indication of a transaction executed on an IP network. In block 402, there may be displayed an indication of one or more packet exchanges on the IP network, where such exchanges were executed or transmitted among relevant nodes of the IP network during an execution of the transaction. In block 404, there may be displayed an indication of an association of the packet exchanges with the transaction so that a user or a processor may determine which exchanges were transmitted or performed in the course of or during a period in which a transaction was executed. In some embodiments the packet exchanges that are associated with a transaction may be classified or categorized with an indication that the packet exchanges were related to or associated with the execution of the transaction. In some embodiments, metrics of one or more of the packet exchanges may be calculated and/or displayed along with an indication that the packet exchanges were related to or associated with the execution of the transaction. Such metrics may include for example a chattiness of the transaction, an average size of the packets, a number of exchanges of packets or other metrics about the transaction, or about the nodes associated with the transaction

It will be appreciated by persons skilled in the art that embodiments of the invention are not limited by what has been particularly shown and described hereinabove. Rather the scope of at least one embodiment of the invention is defined by the claims below.

I claim:

1. A method comprising:
executing a transaction over an IP network;
recording a time of a start of said transaction and a time of an end of said transaction;
recording packet exchanges included in said transaction, said packet exchanges occurring between said time of start and said time of end; and
associating said packet exchanges occurring between said time of start and said time of end with said transaction.

2. The method as in claim 1, wherein said executing a transaction over an IP network comprises executing said transaction over a virtual IP network under a first condition of said virtual IP network, and comprising:
executing said transaction over said virtual IP network under a second condition of said virtual IP network;
recording a time of a start of said transaction over said virtual IP network under said second condition of said virtual IP network and a time of an end of said transaction over said virtual IP network under said second condition of said virtual IP network; and
recording packet exchanges between said at least two nodes on said virtual IP network between said time of start of said transaction over said virtual IP network under said second condition of said virtual IP network and said time of end of said transaction over said virtual IP network under said second condition of said virtual IP network.

3. The method as in claim 1, comprising:
displaying an indication of said packet exchanges occurring between said time of start and said time of end of said transaction,
displaying an indication of said transaction; and
recording an indication of said association of said packet exchanges occurring between said time of start and said time of end of said transaction.

4. The method as in claim 1, wherein said executing a transaction over an IP network comprises executing a first transaction of an application, and comprising:
executing said transaction of a modified version of said application;
recording a time of a start of said transaction of said modified version and a time of an end of said transaction of said modified version;
recording packet exchanges included in said transaction of said modified version among nodes on said IP network between said time of start of said transaction of said modified version and said time of end of said transaction of said modified version; and
displaying said packet exchanges of said transaction of said modified version of said application and packet exchanges of said transaction of said modified version of said application.

5. A method of displaying a network transaction comprising:
displaying an indication of a transaction executed on an IP network;
displaying an indication of a plurality of packet exchanges on said IP network, said plurality of packet exchanges occurring during an execution of said transaction; and
displaying an indication of an association of said packet exchanges with said transaction.

6. The method as in claim 5, comprising calculating a metric of said packet exchanges, said metric selected from the group consisting of a size of a packet, a number of said packet exchanges, and a number of said packet exchanges transmitted by a node on said IP network, a frequency of said packet exchanges.

7. The method as in claim 5, comprising displaying an indication of a time period during which said transaction was executed.

8. The method as in claim 5, comprising displaying an indication of a time period during which said plurality of packet exchanges occurred.

9. The method as in claim 5, comprising displaying an indication of a plurality of said transactions and a plurality of packet exchanges associated with each of said plurality of transactions.

10. The method as in claim 5, wherein said displaying said indication of said transaction comprises displaying an indication of a first transaction executed on said IP network under a first condition of said IP network, and comprising
recording a parameter of a second condition of said IP network;
displaying an indication of an association of packet exchanges in an execution of a second transaction under said second condition;
comparing packet exchanges during said first transaction on said IP network, said IP network under said first condition, with packet exchanges during said second transaction on said IP network, said IP network under said second condition.

11. The method as in claim 5, wherein
said displaying an indication of a transaction executed on an IP network comprises displaying an indication of a first transaction executed on said IP network;
said displaying an indication of a plurality of packet exchanges on said IP network, said plurality of packet exchanges occurring during the execution of said transaction comprises displaying an indication of a first plurality of packet exchanges during the execution of said first transaction; and
said displaying an indication of an association of said packet exchanges with said transaction comprises displaying an indication of an association of said first plurality packet exchanges with said first transaction; and
comprising:
displaying an indication of a second transaction executed on said IP network;
displaying an indication of a second plurality of packet exchanges during an execution of said second transaction;
displaying an indication of an association of said second plurality of packet exchanges with said second transaction; and
comparing said first plurality of packet exchanges associated with said first transaction to said second plurality of packet exchanges associated with said second transaction.

12. A system comprising:
a processor to:
record a time of a start of an execution a transaction over an IP network and a time of an end of said transaction;
record packet exchanges of data included in said transaction, said packet exchanges occurring between said time of start and said time of end; and
a display to display an indication of said packet exchanges as having occurred between said time of start and said time of end.

13. The system as in claim 12, wherein said processor to record said time of said start and said time of said end comprises a processor to record said execution of said transaction under a first condition of a virtual IP network, and wherein said processor is to
record said time of start and said time of end of said execution of said transaction over said virtual IP network under a second condition of said virtual IP network;
record a time of a start of said transaction over said virtual IP network under said second condition of said virtual IP network and a time of an end of said transaction over said virtual IP network under said second condition of said virtual IP network; and
record packet exchanges of data between said two nodes on said virtual IP network between said time of a start of said transaction over said virtual IP network under said second condition of said virtual IP network and said time of end of said transaction over said virtual IP network under said second condition of said virtual IP network.

14. The system as in claim 12, wherein said processor is to associate said packet exchanges and said transaction with a time between said time of start and said time of end.

15. The system as in claim 11, wherein said processor to execute a transaction of an application over an IP network comprises said processor to execute a first transaction of an application, and wherein said processor is to:
execute said transaction of a modified version of said application;
record a time of a start of said transaction of said modified version and a time of an end of said transaction of said modified version;
record packet exchanges included in said transaction on said modified version among nodes on said IP network between said time of start of said transaction on said modified version and said time of end of said transaction on said modified version; and
said display is to display an indication of said packet exchanges included in said transaction on said modified version.

16. An article having stored thereon instructions that when executed result in:
recording an indication of a transaction executed on an IP network;
recording an indication of a plurality of packet exchanges between nodes on said IP network during the execution of said transaction; and
recording an indication of an association of said packet exchanges with said transaction.

17. The article as in claim 16, comprising instructions that upon execution result in displaying an indication that said packet exchanges were executed during said transaction.

18. The article as in claim 16, wherein said instructions upon execution result in displaying an indication of a time period during which said transaction was executed.

19. The article as in claim 16, wherein said instructions upon execution result in displaying an indication of a time period during which said packet exchanges occurred.

20. The article as in claim 16, wherein said instructions upon execution result in calculating a metric of said packet exchanges included in said transaction.
